(19) United States
(12) Patent Application Publication
(10) Pub. No.: US 2002/0050108 A1
(43) Pub. Date: May 2, 2002

(54) Clamp fitting for fastening glass plates

(76) Inventors: Ralf Kreyenborg, Bad Salzuflen (DE); Dirk Schulte, Bad Driburg (DE)

Correspondence Address: NILS H. LJUNGMAN & ASSOCIATES, P. O. BOX 130, GREENSBURG, PA, 15601-0130, US

(21) Appl. No.: 09/835,865

(22) Filed: Apr. 16, 2001

Related U.S. Application Data
(63) Continuation-in-part of application No. PCT/EP00/07941, filed on Aug. 15, 2000.

(30) Foreign Application Priority Data
Aug. 17, 1999 (DE) 199 38 571.4

(51) Int. Cl. E04G 25/00; E04H 3/00; E04H 5/00; E04H 6/00; E04H 14/00; E04B 5/46; E04C 1/42; E04H 1/00

(52) U.S. Cl. 52/306; 52/235; 52/307; 52/308; 248/200.1

(57) ABSTRACT

A clamp fixture to fasten glass plates that are clamped between an inner clamp element and an external clamp element, whereby a clamp bolt is supported elastically, to a limited extent, on the inner clamp element by means of a bush. The invention teaches that the inner clamp element, on the side facing the substructure, has a cylindrical receptacle space to hold the bearing that supports the clamp bolt in the axial direction, whereby the bearing is realized optionally in the form of a fixed bearing, in the form of a friction bearing that intersects the center longitudinal axis of the clamp bolt, or in the form of a movable bearing for the four-point bearing of a glass plate.

### CONTINUING APPLICATION DATA

This application is a Continuation-In-Part application of International Patent Application No. PCT/EP00/07941, filed on Aug. 15, 2000, which claims priority from Federal Republic of Germany Patent Application No. 199 38 571.4, filed on Aug. 17, 1999. International Patent Application No. PCT/EP00/07941 was pending as of the filing date of this application. The United States was an elected state in International Patent Application No. PCT/EP00/07941.

### BACKGROUND OF THE INVENTION

1. Field of the Invention

This invention relates to a clamp fitting for fastening glass plates with an outer and an inner clamp element that clamp the glass plate between them and a clamp bolt that can be connected with a substructure, which clamp bolt is supported elastically, to a limited extent, on the inner clamp element by means of a bush that surrounds the clamp bolt.

2. Background of the Invention

A device of the type described above is disclosed in Federal Republic of Germany Patent Application No. 197 13 678 A1. On this clamp fixture of the prior art, a clamp element on the inside of the building is connected to a bush that surrounds the clamp bolt, which bush is elastically supported by O-rings on a flange of the clamp element on the inside of the building. This support is primarily to absorb the stresses that are exerted on the glass plate after installation. However, the support also makes it possible to adjust the glass plate and/or the clamp elements that are enclosing the glass plate relative to the position of the clamp bolt that can be connected with the substructure if, in the realization of the prior art, a distance bolt that surrounds the clamp bolt is located at a variable angle with respect to the clamp element on the inside of the building. The result is a limited relative movement of the clamp element on the inside of the building with respect to the bolt shank of the clamp bolt in all six degrees of freedom.

The invention is based on the observation that glass plates, for example those used to cover facades, are fastened by means of a four-point bearing. It is thereby desirable to first connect the glass plate to the substructure by means of a fixed bearing point, whereby the other three bearing points must be equipped so that both construction tolerances as well as loads on the glass plate after installation caused by thermal stresses or wind pressure can be reliably absorbed. This capability necessarily requires a different configuration of the individual clamp fittings.

### OBJECT OF THE INVENTION:

The object of the invention, taking the requirements described above into consideration, is to realize the individual clamp fittings for the four-point bearing so that essentially identical components can be used to the greatest possible extent to arrive at a solution that is economical and easy to install.

### SUMMARY OF THE INVENTION:

The invention teaches that this object can be accomplished by a clamp fixture for fastening glass plates with an outer clamp element and an inner clamp element that clamp the glass plate between them and a clamp bolt that can be connected with a substructure, which clamp bolt is supported elastically, to a limited extent, on the inner clamp element by means of a bush that surrounds the clamp bolt, characterized by the fact that the inner clamp element (6), on the side facing the substructure, has a cylindrical receptacle space (10) to hold a bearing (3, 4, 5) that supports the clamp bolt (8) in the axial direction (Arrow Z), whereby the clamp bolt (8) can be supported optionally in the axial direction (Arrow Z) without play (fixed bearing), in a plane that intersects the center longitudinal axis (11) and in the axial direction (Arrow Z) with play (12, 13) (friction bearing 4), or with axial play (14) and play (15) on all sides in the peripheral direction (movable bearing 5) in the bearing (3, 4, 5).

The present invention teaches that an inner clamping element, on the side facing the substructure, has a cylindrical receptacle space to hold a bearing that supports the clamping bolt in the axial direction, whereby the clamp bolt can be supported in the bearing optionally in the axial direction with no play, in a plane that intersects the center longitudinal axis and in the axial direction with play, or with axial play and peripheral play in all directions.

The invention teaches the use in all cases of a clamp element of essentially identical construction on the outside of the building and on the inside of the building. With the first partial characteristic, namely the realization of the bearing such that the clamp bolt can be supported in the bearing in the axial direction without play, a fixed bearing is created.

With the second partial characteristic, namely the support of the clamp bolt in the clamp element on the inside of the building in a plane that intersects the center longitudinal axis and in the axial direction with play, a vertical bearing or friction bearing is created which, even after installation, allows a movement of the clamp bolt with respect to the clamp bolt on the inside of the building in a plane.

With the third partial characteristic, namely the mounting of the clamp bolt in the clamp element on the inside of the building with axial play and peripheral play on all sides, a movable bearing is finally created that allows a movement of the pane with respect to the clamp fitting both in the horizontal and in the vertical direction, i.e. for example in an X plane or in a Y plane.

With the solution claimed by the invention, different degrees of freedom for the clamp bolt supported in the above mentioned bearing are created merely by slightly modifying the configuration of the bearing held by the inner clamp element, without requiring a modification to the clamp element on the inside of the building. Thus a tolerance compensation is possible both during installation as a result of manufacturing tolerances, and after installation as a result of stresses that act on the glass plate.

Additional characteristics of the invention are disclosed herein below in the features of the invention.

The invention teaches that the bearing is realized so that it has a compensating bush that surrounds the bolt shank of the clamp bolt without play and a spacer bush that surrounds the compensating bush, whereby the spacer bush has on its outside periphery a flange by means of which the bearing is supported elastically, to a limited extent, by elastic means, for example by O-rings on the inner clamping element. This support allows limited vertical adjustability, for example plus or minus two millimeters, even in the fixed bearing.

To achieve a fixed bearing, the invention teaches that the compensating bush is fixed in position in the axial direction on the spacer bush without play, whereby the compensating bush is supported on one hand on a collar of the spacer bush and on the other hand by means of a nut that is screwed onto the spacer bush with the compensating bush. To thereby substantially eliminate all play, a distance washer is located between the nut and the end surface of the spacer bush. Thus—apart from the support of the bearing by means of the O-rings described above, all movement of the clamp bolt with respect to the clamp element on the inside of the building is prevented.

The invention further teaches that the spacer bush has a recess or boring with a hole-like cross section, whereby the compensating bush is supported by means of an essentially oval or elliptical bush head on a collar of the spacer bush. In the fixed bearing described above, a displacement or travel of the clamp bolt in the slot-like recess of the compensating bush is reliably prevented by the axial clamping, while the invention further teaches that to achieve a friction bearing, there is axial play between the nut that is screwed to the compensating bush and the spacer bush. As a result of the omission of the axial clamping, the compensating bush can slide into the slot-like recess of the spacer bush even after installation, so that the result is a compensation capability in a plane that intersects the center longitudinal axis of the clamp bolt.

As will be explained in greater detail below with reference to the exemplary embodiment, this is achieved by omitting the above mentioned distance washer associated with the fixed bearing, so that the only constructive difference between the fixed bearing and the friction bearing or vertical bearing is the omission of the distance washer.

A slight constructive modification of the configuration of the bearing results in the achievement of a movable bearing, whereby, however, the clamp element on the inside of the building described above is used in an identical fashion. To achieve a movable bearing, both the compensating bushes and the spacer bush have concentric borings, whereby the spacer bush surrounds the compensating bush with radial play and is mounted with axial play between the bolt head of the clamp bolt and a flange of the compensating bush. The constructive difference therefore comprises the configuration of the spacer bush on the one hand and the compensating bush on the other hand, although it essentially guarantees a movement of the clamp bolt with respect to the clamp element on the inside of the building in four degrees of freedom.

In all three embodiments, both with the fixed bearing, the friction bearing and the movable bearing, the compensating bush has a threaded sleeve that points toward the substructure, which threaded sleeve holds a locknut that is pressed against the substructure.

The result of the invention is the creation of a clamp fitting with which, while retaining essentially identical components, different degrees of freedom of the clamp fitting with respect to the glass plate can be achieved.

In other words, the present invention broadly teaches that a glass pane can be fastened to a substructure by means of four clamp fittings (one in each corner of the glass pane) each comprising an outer clamp element and an inner clamp element. The four clamp fittings are substantially identical, however, there are differences in functionality: a fixed bearing with limited vertical adjustability, probably, in at least one possible embodiment, plus or minus two millimeters, a vertical bearing (also referred to as a friction bearing with play in a vertical direction), and two movable bearings probably in four degrees of freedom. Slight constructive modifications of the configuration of the bearings are necessary in order to allow for the differences in functionality. These slight modifications enable the usage of identical components in the three different bearings to be used at the greatest possible extent. The invention is therefore an economical solution as well as a user-friendly product.

The above-discussed embodiments of the present invention will be described further hereinbelow. When the word “invention” is used in this specification, the word “invention” includes “inventions ”, that is the plural of “invention ”. By stating “invention ”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The invention is explained in greater detail below on the basis of three exemplary embodiments illustrated in the accompanying figures, in which:

FIG. 1: is a schematic view of a four-point bearing

FIG. 2: is the legend for the individual clamp fittings illustrated in FIG. 1.

FIG. 3: is a cross section through a fixed bearing.

FIG. 4: is a view of the embodiment illustrated in

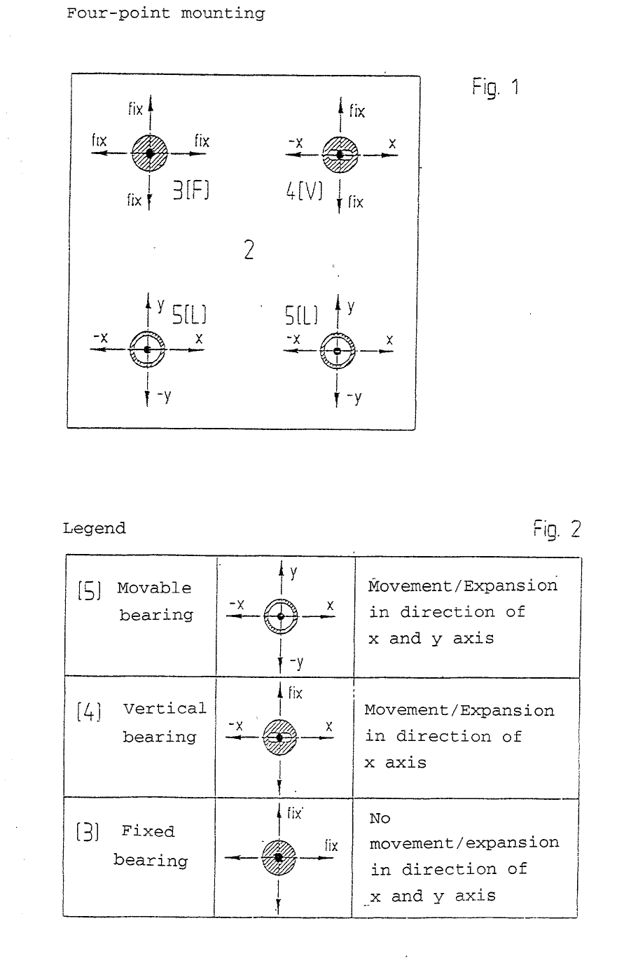

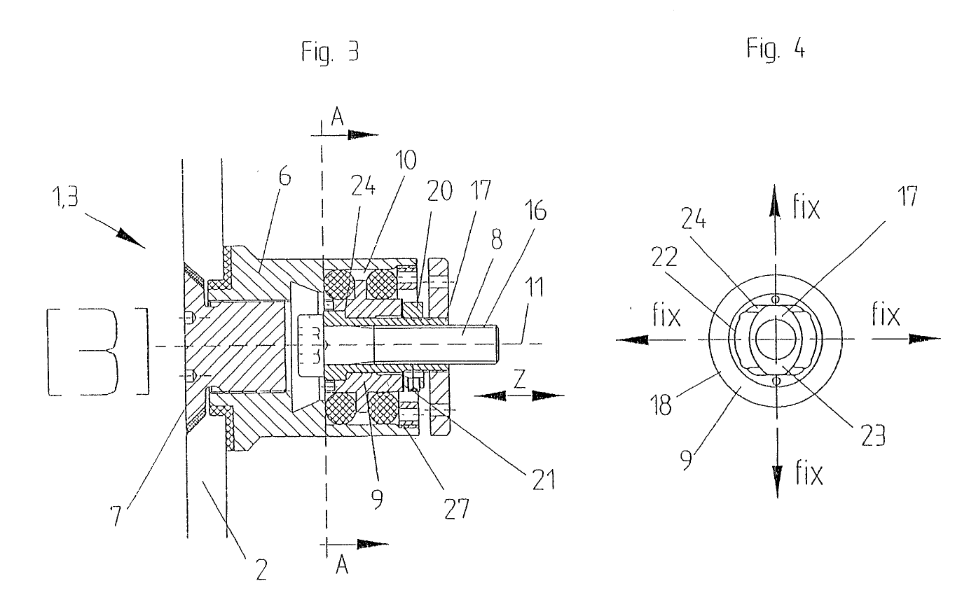

FIG. 3 in the direction of Arrow A-A.

FIG. 5: is a cross section through a friction bearing or vertical bearing.

FIG. 6: is a view of the embodiment illustrated in FIG. 5 in the direction of Arrow B-B.

FIG. 7: is a cross section through a movable bearing.

FIG. 8: is a view of the embodiment illustrated in FIG. 7 in the direction of Arrow C-C.

FIG. 9: is a cross section through a fixed bearing, which is representative of all the bearings.

### DESCRIPTION OF THE PREFERRED EMBODIMENT

In FIG. 1, on a glass plate designated as 2, there are a fixed bearing 3, a friction or vertical bearing 4, and two loose bearings 5, by means of which the glass plate 2 is fastened to a substructure (not shown). The fixed bearing designated F can be adjusted only to the extent of the play that is conventional in bearing parts, e.g. by plus or minus approximately two millimeters, on account of the support of a spacer bush 9 by means of O-rings 30 that are described below. The vertical bearing designated V permits movement only in a plane through a center longitudinal axis 11 of the fastening bolt, whereby this plane can be oriented as desired, for example, in the X direction or in the Y-direction. The movable bearing designated L, on the other hand, permits a movement of the fastening bolt orthogonally with respect to the center longitudinal axis 11 of the bolt in all directions.

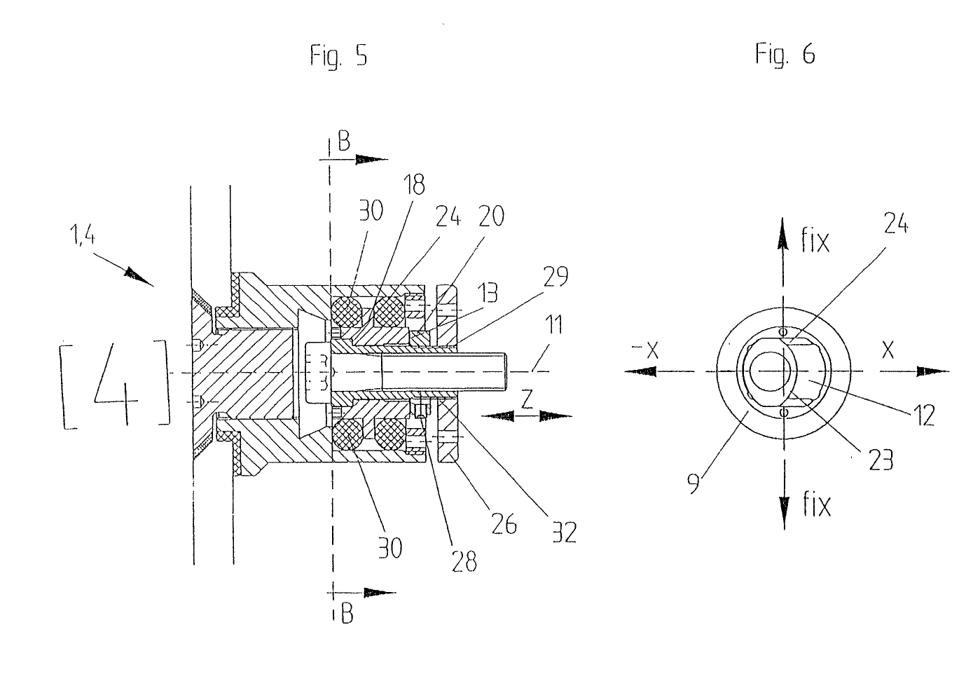

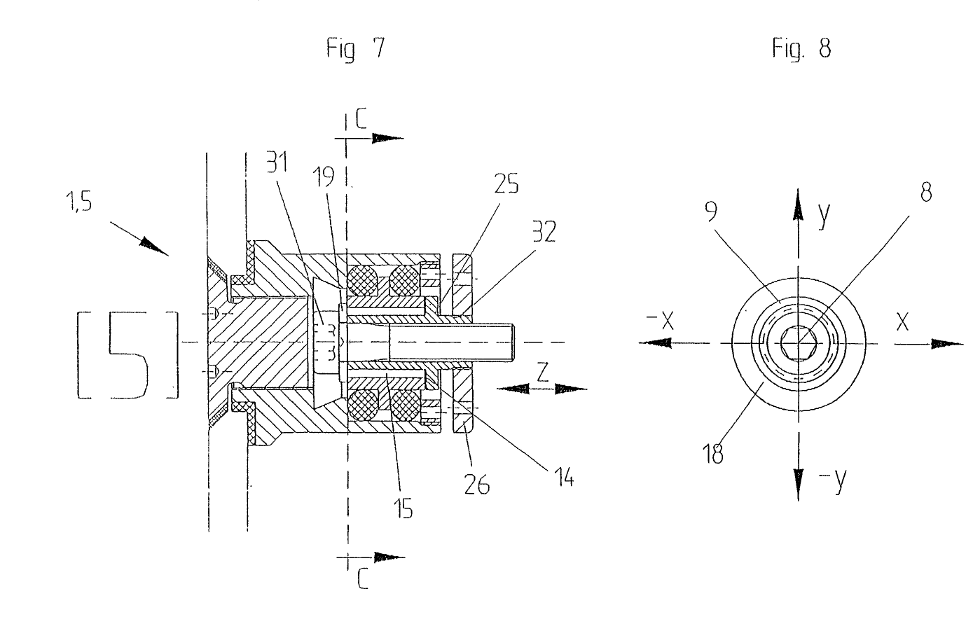

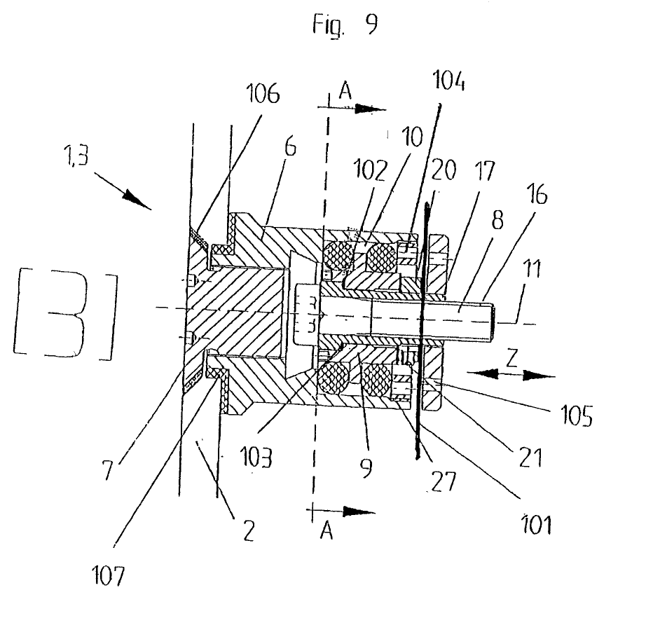

The fixed bearing 3 shown in cross section in FIG. 3, like the friction bearing 4 and the movable bearing 5, has an inner clamp element 6 and an outer clamp element 7. On the side of the clamp element 7 directed toward the substructure (not shown), the clamp element 7 has a cylindrical receptacle space 10 that holds the actual fixed bearing 3. The fixed bearing 3 comprises essentially a compensating bush 17 that surrounds the clamp bolt 8 and the spacer bush 9 that surrounds the compensating bush 17, which spacer bush 9 has a recess or boring 22 with a slot-shaped recess (See FIG. 4). The compensating bush 17, on its free end toward the substructure (not shown), an external screw thread onto which a nut 20 is screwed. Between the nut 20 and the end surface of the spacer bush 9 facing the nut 20 there is a distance washer 21, by means of which the spacer bush 9 is clamped with the compensating bush 17 and thus with the clamp bolt in the axial direction of the clamp bolt 8 (Arrow Z).

The spacer bush 9 also has a flange 18 (See FIG. 5), which is engaged between two O-rings (30), which, for their part, are fixed in position by means of a clamping ring (tension ring) 27 which is screwed into an internal screw thread of the inner clamp element 6. The clamp bolt 8 clamped as described above is supported with its oval—or elliptically-shaped bush head 23 on a collar 24 of the spacer bush 9.

The exemplary embodiment illustrated in FIGS. 5 and 6 shows the realization of a vertical or friction bearing in which the clamp bolt 8 is guided with its bush head 23 so that it slides in the slot-like recess 22 of the spacer bush 9. The result is a lateral displacement capability for the clamp bolt 8 in the X-direction shown in FIG. 6 in the context of a play designated as 12. For this purpose, the distance washer 21 described with reference to FIG. 3 has been removed, so that there is an axial play designated 13 of the spacer bush 9 between the collar 24 of the spacer bush and the nut 20.

For this purpose, a thread designated 29 on the outside periphery of the compensating bush 17 is sized so that the nut 20 can be tightened against the end stop of the thread 29. The nut 20 can also be fixed in its end position by a stud screw 28.

FIGS. 7 and 8 show a clamp fitting 1 realized in the form of a movable bearing 5, i.e. the compensating bush 17 and the spacer bush 9 concentrically surround a bolt shank 16 of the clamp bolt 8. For that purpose, the compensating bush 17 has a flange 25 between which flange 25 and a shim washer 19, which shim washer 19 is in contact with the screw (or bolt) head 31 of the clamp screw (or bolt) 8, the spacer bush 9 is located with radial play 14 and axial play 15. This makes possible both a slight axial movement (Arrow Z) as well as a radial movement of the clamp bolt 8 within the inner clamp element 6, as indicated in FIG. 8 by the arrows X and Y.

In the vicinity of the free end of the compensating bush 17 pointing toward the substructure 17 there is a threaded sleeve 32 onto which a locknut 26 that can be adjusted in relation to the substructure by means of the screw thread 29 is screwed.

In other words, the present invention broadly teaches that a glass plate (2) can be fastened to a substructure (101) by means of four clamp fittings (1)(one in each corner of the glass plate) each comprising an outer clamp element (7) and an inner clamp element (6). The four clamp fittings (1) are by and large identical, however, as seen in FIG. 1 there are differences in functionality that offers different degrees of freedom for the clamp bolt (8). A fixed bearing (3) with limited vertical adjustability, probably plus or minus two millimeters, a vertical bearing (V) (also referred to as a friction bearing (4) with play in a vertical direction), and two movable bearings (5) probably in four degrees of freedom. Slight constructive modifications of the configuration of the bearings are necessary in order to allow for the differences in functionality, these slight modifications enable the usage of identical components in the three different bearings to be used at the greatest possible extent.

FIGS. 3, 4, 5, 6, 7, 8 and 9 broadly show a clamp fitting (1) with an outer clamp element (7) and an inner clamp element (6) between which a glass plate (2) is clamped. Further, FIG. 9 shows the substructure (101) to which the bearings (3, 4 and 5) are connected by means of a locknut (26). The previously mentioned constructive modifications of the configurations of the bearings (3, 4 and 5) are possibly all in the inner clamp element (6).

FIG. 3 and 9 broadly show a fixed bearing (3) in which a clamp bolt (8) is surrounded by a compensating bush (17) and a spacer bush (9) that surrounds said compensating bush (17). Both the compensating bush (17) and the surrounding spacer bush (9) preferably have a small collar or flange (102 and 103) that broadly fit into each other for support only separated by a distance washer (24).

To possibly eliminate all play, a distance washer (21) is placed at the end surface of the spacer bush (9) (facing the substructure (101)), and a nut (20) broadly screws onto the thread of the compensating bush (17) clamping the distance washer (21) with the spacer bush (9). To further ensure that the fixed bearing (3) has no play a stud screw (28) can fix the nut (20) in its end position.

The spacer bush (9) possibly has a flange (18) which is engaged between two rows of O-rings (30), the flange (18) however, does not completely separate the rows of O-rings (30) but preferably leaves a cylindrical receptacle space (10), which space (10) together with the O-rings probably allows a limited vertical adjustability plus or minus two millimeters. To preferably keep the O-rings (30) in place a tension ring (27) is screwed into the inside of the inner clamp element (6). Both the tension ring (27) and the locknut (26) probably has an adequate number of screw holes (104 and 105), so once the inner clamp element (6) has been placed and fastened with the locknut (26) small bolts can preferably be screwed from the inside of the substructure (101) through both locknut (26) and the substructure (101) itself and into the tension ring (27) and thereby ensure the immobility of both the locknut (26) and the tension ring (27).

FIG. 5 broadly shows a vertical bearing (V) also referred to as a friction bearing (4). The vertical bearing (V) is probably almost exactly identical in construction as the fixed bearing (3), with only one small difference, namely the omission of the distance washer (21) whereby an axial clamping is possibly eliminated. The elimination of the axial clamping will broadly permit movement through the center longitudinal axis (11) and thereby possibly allow for a choice of direction (in the X-direction or the Y-direction) depending on the need.

FIG. 7 broadly shows a movable bearing (5). The object of the movable bearing (5) is possibly to realize a bearing with both axial play and radial play. The axial play is preferably achieved by omitting the distance washer (21) (as in the friction bearing (4)). The radial play, however, is broadly achieved by a constructive difference in the configuration of both the spacer bush (9) and the compensating bush (17).

As shown in FIG. 7, in this case both the spacer bush (9) and the compensating bush (17) are possibly realized without collar (102 and 103). The omission of the collars (102 and 103) possibly render essentially impossible for the spacer bush (9) and the compensating bush (17) to rest on each other and instead the omission makes room for a play (15). Furthermore, the compensating bush (17) possibly has a flange (25) which together with the shim washer (19) surrounds the spacer bush (9).

These constructive differences in the configuration of both the spacer bush (9) and the compensating bush (17) will broadly allow for the desired radial play.

FIG. 9 shows the mounting of a glass plate (2) by means of the bearings (3, 4 and 5) to a substructure (101) can possibly be done two ways. In the first case the inner clamp elements (6) of the different bearings (3, 4 and 5) should preferably be fastened and secured to the substructure (101) and once the four inner clamp elements (6) are in place, the glass plate (2) can broadly be mounted by screwing the outer clamp element (7) through the glass plate (2) and into the inner clamp element (6). In the second case the four bearings (3, 4 and 5) are first connected to the glass plate (2) and then the bearings (3, 4 and 5) are connected, fastened and secured to the substructure (101). In both cases the fixed bearing (3) should broadly be installed first, secondly the vertical bearing (V) also referred to as the friction bearing (4) should be installed, and finally the two movable bearings probably without any individual order can be installed. To be able to fully exploit the flexibility this invention offers it preferably necessary to apply this order of installation.

In order to protect the glass plate (2) from being damaged by the clamp fittings both (1) during installation as well as after installation due to possible thermal stresses and wind pressure, the outer clamp element (7) and inner clamp element (6) where touching the glass plate (2) should both preferably be fitted with a protecting sleeve or a tight bushing(106 and 107) made out of e.g. Teflon, neoprene, nylon, plastic or rubber.

One feature of the invention resides broadly in a clamp fixture for fastening glass plates with an outer clamp element and an inner clamp element that clamp the glass plate between them and a clamp bolt that can be connected with a substructure, which clamp bolt is supported elastically, to a limited extent, on the inner clamp element by means of a bush that surrounds the clamp bolt, characterized by the fact that the inner clamp element 6, on the side facing the substructure, has a cylindrical receptacle space 10 to hold a bearing 3, 4, 5 that supports the clamp bolt 8 in the axial direction Arrow Z, whereby the clamp bolt 8 can be supported optionally in the axial direction Arrow Z without play fixed bearing, in a plane that intersects the center longitudinal axis 11 and in the axial direction Arrow Z with play 12, 13 (friction bearing 4), or with axial play 14 and play 15 on all sides in the peripheral direction movable bearing 5 in the bearing 3, 4, 5.

Another feature of the invention resides broadly in a clamp fixture characterized by the fact that the bearing 3, 4, 5 has a compensating bush 17 that surrounds a bolt shank 16 of the clamp bolt 18 without play, and a spacer bush 9 that surrounds the compensating bush 17.

Yet another feature of the invention resides broadly in a clamp fixture characterized by the fact that the spacer bush 9, on its outer periphery, has a flange 18, by means of which the bearing 3, 4, 5 is supported to a limited elastic extend by means of elastic means O-rings 30 on the inner clamp element 6.

Still another feature of the invention resides broadly in a clamp fixture characterized by the fact that to achieve a fixed bearing 3, the compensating bush 17 is fixed in position in the axial direction Arrow Z on the spacer bush 9.

A further feature of the invention resides broadly in a clamp fixture characterized by the fact that the compensating bush 17 is supported on one hand on a collar 24 of the spacer bush 9 and on the other hand by means of a nut 20 that is screwed together with the compensating bush 17 on the spacer bush 9.

Another feature of the invention resides broadly in a clamp fixture characterized by the fact that a distance washer 21 is located between the nut 20 and the end surface of the spacer bush 9.

Yet another feature of the invention resides broadly in a clamp fixture characterized by the fact that the spacer bush 9 has a recess or hole that has a slot-shaped cross section, and the compensating bush 17 is supported with an essentially oval or elliptical bush head 23 on a collar 24 of the spacer bush 9.

Still another feature of the invention resides broadly in a clamp fixture characterized by the fact that to achieve a friction bearing 4, there is axial play 13 between the nut 20 that is screwed to the compensating bush 17 and the spacer bush 9.

A further feature of the invention resides broadly in a clamp fixture characterized by the fact that to achieve a movable bearing 5, both the compensating bush 17 and the spacer bush 9 have concentric borings, whereby the spacer bush 9 surrounds the compensating bush 17 with radial play or clearance 15 and is mounted with axial play 14 between a bolt head 31 of the clamp bolt and a flange 25 of the compensating bush 17.

Another feature of the invention resides broadly in a clamp fixture characterized by the fact that the compensating bush 17 has a threaded sleeve 32 that points toward the substructure to accept a locknut 26.

The components disclosed in the various publications, disclosed or incorporated by reference herein, may be used in the embodiments of the present invention, as well as equivalents thereof.

The appended drawings in their entirety, including all dimensions, proportions and/or shapes in at least one embodiment of the invention, are accurate and are hereby included by reference into this specification.

All, or substantially all, of the components and methods of the various embodiments may be used with at least one embodiment or all of the embodiments, if more than one embodiment is described herein.

All of the patents, patent applications and publications recited herein, and in the Declaration attached hereto, are hereby incorporated by reference as if set forth in their entirety herein.

The corresponding foreign and international patent publication applications, namely, Federal Republic of Germany Patent Application No. 199 38 571.8 , filed on Aug. 17, 1999, having inventors Ralf KREYENBORG, Dirk SCHULTE, and Ernst Udo BLÖBAUM, and International Application No. PCT/EP00/07941, filed on Aug. 15, 2000, having inventors Ralf KREYENBORG, Dirk SCHULTE, and Ernst Udo BLÖBAUM, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

U.S. Pat. No. 6,158,177, having inventor Blöbaum, issued on Dec. 12, 2000 is hereby incorporated by reference as if set forth in its entirety herein.

The details in the patents, patent applications and publications may be considered to be incorporable, at applicant's option, into the claims during prosecution as further limitations in the claims to patentably distinguish any amended claims from any applied prior art.

The invention as described hereinabove in the context of the preferred embodiments is not to be taken as limited to all of the provided details thereof, since modifications and variations thereof may be made without departing from the spirit and scope of the invention.

Some examples of glass mountings or glass mounting devices which may possibly be utilized or adapted for use in the context of the present invention may be found in the following U.S. Pat. No.: 5,323,577, issued on Jun. 28, 1994 to Witmyer; U.S. Pat. No. 5,283,978, issued on Feb. 8, 1994 to Horgan, Jr.; U.S. Pat. No. 5,212,922, issued on May 25, 1993 to Werner: U.S. Pat. No. 4,841,697, issued on Jun. 27, 1989 to Hogg, et al.; U.S. Pat. No. 4,097,320, issued on Oct. 18, 1977 to Sher; and U.S. Pat. No. 4,016,690, issued on Apr. 12, 1997 to Richardson.

Some examples of glass facades and methods of securing glass panels of a facade which may possibly be utilized or adapted for use in the context of the present invention may be found in the following U.S. patents. Nos.: U.S. Pat. No. 5,493,831, issued on Feb. 27, 1996 to Jansson: U.S. Pat. No. 5,301,484, issued on Apr. 12, 1994 to Jansson; U.S. Pat. No. 4,837,996, issued on Jun. 13, 1989 to Eckelt; and U.S. Pat. No. 4,793,112, issued on Dec. 27, 1988 to Sufke.

| 1 | Clamp fitting |
|---|---|
| 2 | Glass plate |
| 3 | Fixed bearing |
| 4 | Friction bearing |
| 5 | Movable bearing |
| 6 | Inner clamp element |
| 7 | Outer clamp element |
| 8 | Clamp bolt |
| 9 | Spacer bush |
| 10 | Cylindrical receptacle space |
| 11 | Center longitudinal axis |
| 12 | Play |
| 13 | Play |
| 14 | Play |
| 15 | Play |
| 16 | Bolt shank |
| 17 | Compensating bush |
| 18 | Flange |
| 19 | Shim washer |
| 20 | Nut |
| 21 | Distance washer |
| 22 | Slot-shaped recess |
| 23 | Bush head |
| 24 | Collar of distance washer |
| 25 | Flange |
| 26 | Locknut |
| 27 | Tension ring |
| 28 | Stud screw |
| 29 | Thread |
| 30 | O-rings |
| 31 | Bolt head of the clamp bolt |
| 32 | Threaded sleeve |
| Arrow Z | Axial direction |
| F | Fixed bearing |
| V | Vertical bearing |
| L | Movable bearing |
| X | Direction |
| Y | Direction |
| 101 | Substructure |
| 102 | Collar/flange |
| 103 | Collar/flange |
| 104 | Screw hole |
| 105 | Screw hole |
| 106 | Protecting sleeve/tight bushing |
| 107 | Protecting sleeve/tight bushing |

What is claimed is:

1. A glass facade for a building structure having a clamp fixture for fastening glass plates with an outer clamp element and an inner clamp element that clamp the glass plate between them and a clamp bolt that can be connected with a substructure, which clamp bolt is supported elastically, to a limited extent, on the inner clamp element by means of a bush that surrounds the clamp bolt, characterized by the fact that the inner clamp element (6), on the side facing the substructure, has a cylindrical receptacle space (10) to hold a bearing (3, 4, 5) that supports the clamp bolt (8) in the axial direction (Arrow Z), whereby the clamp bolt (8) can be supported optionally in the axial direction (Arrow Z) without play (fixed bearing), in a plane that intersects the center longitudinal axis (11) and in the axial direction (Arrow Z) with play (12, 13) (friction bearing 4), or with axial play (14) and play (15) on all sides in the peripheral direction (movable bearing 5) in the bearing (3, 4, 5).

2. A Clamp fixture for fastening glass plates with an outer clamp element and an inner clamp element that clamp the glass plate between them and a clamp bolt that can be connected with a substructure, which clamp bolt is supported elastically, to a limited extent, on the inner clamp element by means of a bush that surrounds the clamp bolt, characterized by the fact that the inner clamp element (6), on the side facing the substructure, has a cylindrical receptacle space (10) to hold a bearing (3, 4, 5) that supports the clamp bolt (8) in the axial direction (Arrow Z), whereby the clamp bolt (8) can be supported optionally in the axial direction (Arrow Z) without play (fixed bearing), in a plane that intersects the center longitudinal axis (11) and in the axial direction (Arrow Z) with play (12, 13) (friction bearing 4), or with axial play (14) and play (15) on all sides in the peripheral direction (movable bearing 5) in the bearing (3, 4, 5).

3. Clamp fixture as claimed in claim 2, characterized by the fact that the bearing (3, 4, 5) has a compensating bush (17) that surrounds a bolt shank (16) of the clamp bolt (18) without play, and a spacer bush (9) that surrounds the compensating bush (17).

4. Clamp fixture as claimed in claim 2, characterized by the fact that the spacer bush (9), on its outer periphery, has a flange (18), by means of which the bearing (3, 4, 5) is supported to a limited elastic extend by means of elastic means (O-rings 30) on the inner clamp element (6).

5. Clamp fixture as claimed in claim 3, characterized by the fact that the spacer bush (9), on its outer periphery, has a flange (18), by means of which the bearing (3, 4, 5) is supported to a limited elastic extend by means of elastic means (O-rings 30) on the inner clamp element (6).

6. Clamp fixture as claimed in claim 2, characterized by the fact that to achieve a fixed bearing (3), the compensating bush (17) is fixed in position in the axial direction (Arrow Z) on the spacer bush (9).

7. Clamp fixture as claimed in claim 3, characterized by the fact that to achieve a fixed bearing (3), the compensating bush (17) is fixed in position in the axial direction (Arrow Z) on the spacer bush (9).

8. Clamp fixture as claimed in claim 4, characterized by the fact that to achieve a fixed bearing (3), the compensating bush (17) is fixed in position in the axial direction (Arrow Z) on the spacer bush (9).

9. Clamp fixture as claimed in claim 8, characterized by the fact that the compensating bush (17) is supported on one hand on a collar (24) of the spacer bush (9) and on the other hand by means of a nut (20) that is screwed together with the compensating bush (17) on the spacer bush (9).

10. Clamp fixture as claimed in claim 8, characterized by the fact that a distance washer (21) is located between the nut (20) and the end surface of the spacer bush (9).

11. Clamp fixture as claimed in claim 9, characterized by the fact that a distance washer (21) is located between the nut (20) and the end surface of the spacer bush (9).

12. Clamp fixture as claimed in claim 2, characterized by the fact that the spacer bush (9) has a recess or hole that has a slot-shaped cross section, and the compensating bush (17) is supported with an essentially oval or elliptical bush head (23) on a collar (24) of the spacer bush (9).

13. Clamp fixture as claimed in claim 11, characterized by the fact that the spacer bush (9) has a recess or hole that has a slot-shaped cross section, and the compensating bush (17) is supported with an essentially oval or elliptical bush head (23) on a collar (24) of the spacer bush (9).

14. Clamp fixture as claimed in claim 2, characterized by the fact that to achieve a friction bearing (4), there is axial play (13) between the nut (20) that is screwed to the compensating bush (17) and the spacer bush (9).

15. Clamp fixture as claimed in claim 13, characterized by the fact that to achieve a friction bearing (4), there is axial play (13) between the nut (20) that is screwed to the compensating bush (17) and the spacer bush (9).

16. Clamp fixture as claimed in claim 2, characterized by the fact that to achieve a movable bearing (5), both the compensating bush (17) and the spacer bush (9) have concentric borings, whereby the spacer bush (9) surrounds the compensating bush (17) with radial play or clearance (15) and is mounted with axial play (14) between a bolt head (31) of the clamp bolt and a flange (25) of the compensating bush (17).

17. Clamp fixture as claimed in claim 15, characterized by the fact that to achieve a movable bearing (5), both the compensating bush (17) and the spacer bush (9) have concentric borings, whereby the spacer bush (9) surrounds the compensating bush (17) with radial play or clearance (15) and is mounted with axial play (14) between a bolt head (31) of the clamp bolt and a flange (25) of the compensating bush (17).

18. Clamp fixture as claimed in claim 2, characterized by the fact that the compensating bush (17) has a threaded sleeve (32) that points toward the substructure to accept a locknut (26).

19. Clamp fixture as claimed in claim 17, characterized by the fact that the compensating bush (17) has a threaded sleeve (32) a that points toward the substructure to accept a locknut (26).
